(19) United States
(12) Patent Application Publication
(10) Pub. No.: US 2009/0094084 A1
(43) Pub. Date: Apr. 9, 2009

(54) Method and System for Use in Scheduling Transfer of Transportation Assets

(76) Inventors: Eric Rempel, Chicago, IL (US); Todd Berger, Chicago, IL (US); Ryan Kelver, Chicago, IL (US); Andrew Ashbuagh, Wauconda, IL (US); John P. Cook, Chicago, IL (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 11/868,350

(22) Filed: Oct. 5, 2007

(51) Int. Cl. G06Q 10/00; G06F 3/048; G06F 7/06; G06F 17/30

(52) U.S. Cl. 705/8; 715/810; 705/11

(57) ABSTRACT

A method and system for scheduling transfer of transportation assets and freight use a graphical user interface to collect, enter and display transportation asset data and freight data, thus enabling a user to select origin and destination locations for the transportation asset data and freight data on a map displayed on an electronic display screen. The method and system enable a user to associate transportation asset data to the selected locations and upload selected locations and transportation data to a transportation management system for scheduling transfer of transportation assets and freight.

### BACKGROUND

1. Field of the Disclosure

The disclosure relates generally to data entry systems and specifically to graphical data entry systems for posting and matching freight and transportation assets.

2. Related Technology

Many industries need to ship or otherwise transport goods from one point to another during the course of normal business operations. However, many companies are too small to have their own transportation vehicles. Thus, many companies rely on freight forwarding service providers to move the goods. Freight forwarding service providers generally match goods that need transportation with available transportation assets, such as trucks, ships or aircraft. As a result, much of a freight forwarding service provider's efforts are directed to collecting data pertaining to goods needing transportation (hereinafter referred to as “load(s),” “good(s),” or “freight”) and transportation assets. Originally, freight forwarding service providers contacted customers via phone to obtain information and tracked the information by writing down goods in one area and available transportation assets in another area and then attempted to match a good's origin and destination with a transportation asset that could transport the good from the origin to the destination. This repetitive process was very time consuming, manpower intensive and inefficient.

Efforts have been made to use computer systems to facilitate matching loads and available transportation assets. One known computer system is the DAT system produced by TransCorp Inc. This system uses textual data entry (e.g., typing) to log load and transportation asset data. For example, a customer may give an origin and a destination for a load requiring delivery. The freight forwarding service provider logs this information by typing the data in a form field on a computer screen one item at a time. The name of the customer may be typed in one text entry box, the user then tabs or selects the next text entry box and types in the origin and finally, the user tabs or selects another text entry box and types in the destination information. A similar process is repeated for transportation asset information. Many other types of information can be entered into such a system. The system then organizes and displays the load and transportation asset data in a table. A user then may select appropriate transportation assets for available loads. While this method is more efficient than the old paper and pencil method, the data entry portion is still very time consuming and labor intensive.

### SUMMARY

A method and system for scheduling transfer of transportation assets and freight use a graphical user interface to collect, enter and display transportation asset data and freight data, thus enabling a user to select origin and destination locations for the transportation asset data and freight data on a map displayed on an electronic display screen. The method and system enable a user to associate transportation asset data to the selected locations and upload selected locations and transportation data to a transportation management system for scheduling transfer of transportation assets and freight.

### BRIEF DESCRIPTION OF THE DRAWINGS

Objects, features, and advantages of the present invention will become apparent upon reading the following description in conjunction with the drawing figures, in which:

FIG. 1 is a schematic diagram of a graphical interface system for entering load and transportation asset data constructed in accordance with the teachings of the disclosure;

FIG. 2 is a schematic diagram of the graphical interface of FIG. 1 integrated into a larger Transportation Management System (TMS);

FIG. 3. is an example of a computer screen display of the graphical interface of FIG. 1;

FIG. 4 is a schematic diagram of the logic employed by the graphical interface of FIG. 1;

FIG. 5 is a schematic diagram of other systems that may be used to input data into the graphical interface system of FIG. 1; and

FIG. 6 is a schematic diagram of the social network shown in FIG. 5.

### DETAILED DESCRIPTION

In order to gather information about available transportation assets and loads, users (“representatives” or “reps”) contact individual transportation companies and/or individual shipping customers to gather asset information via phone, email or fax. The gathered information is entered into a transportation management system (TMS) for posting to other users and eventual matching of loads and transportation assets to ship the loads to their desired destinations.

A graphical user interface system provides brokers and carriers with greater visibility of real-time transportation assets and freight. The system allows users to post truck and load data and view the posted data nearly instantaneously.

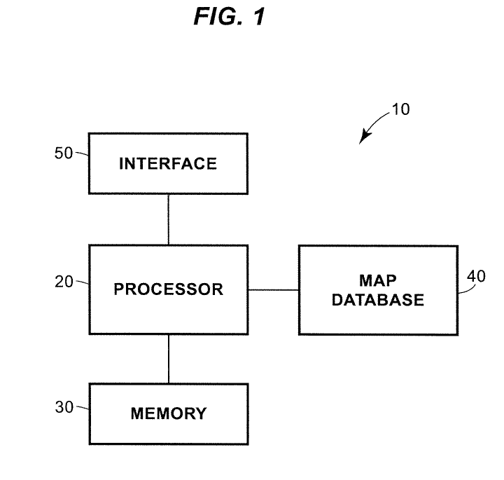

Turning now to FIG. 1, a schematic representation of the graphical interface system 10 is depicted. The graphical interface system includes a processor 20 that may be located in a stand alone computer or a server. The processor 20 is connected to a memory 30 for storage and retrieval of data. Additionally, the processor 20 communicates with a map database 40 to retrieve map information for use in generating a graphical map representation on an interface 50, such as a computer screen, through which a user can input data. The map database 40 may alternatively be contained in the memory 30.

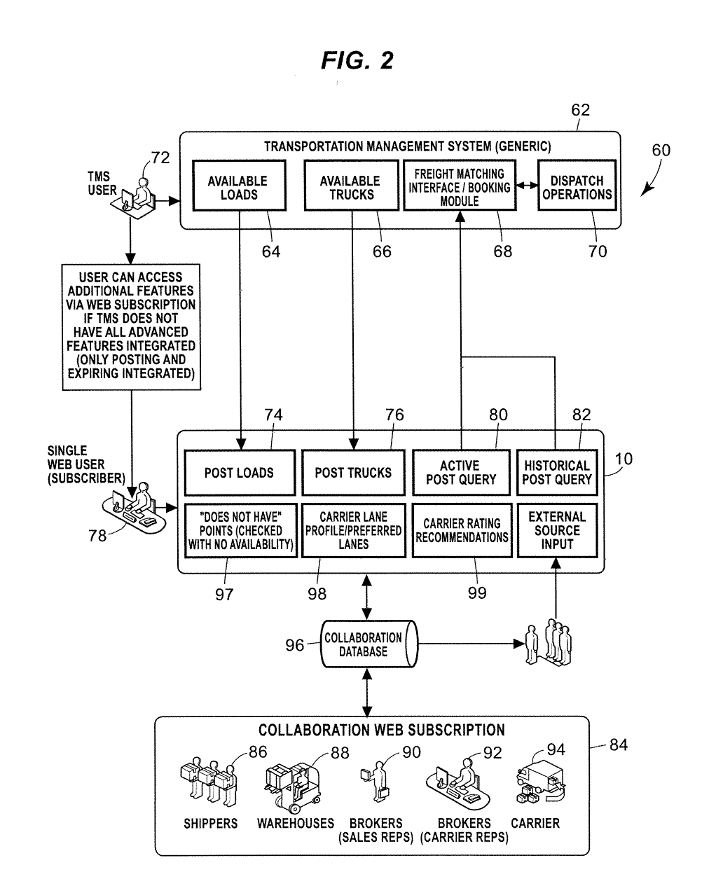

FIG. 2 shows the graphical interface system 10 integrated into a larger Transportation Management System (TMS) 60. The TMS 60 may include a generic TMS module 62 that displays freight 64 and transportation assets 66 data textually (usually in tables). The tables of freight 64 and transportation assets 66 are then matched with one another in a booking module 68. The matched freight and transportation asset data is then transmitted to dispatch 70. Generally a TMS user 72 manually enters the freight and transportation asset data textually into the generic TMS module 62.

The generic TMS module 62 sends available load and transportation asset data to the graphical interface system 10. The information may be sent over the internet, via direct lines, or wirelessly. The available load data is checked and posted to the graphical interface system 10 in a post loads module 74. Likewise, the available transportation asset data is checked and posted to the graphical interface system 10 in a post trucks module 76. Of course, freight and transportation asset data may also be entered by a dedicated user or web based subscriber 78.

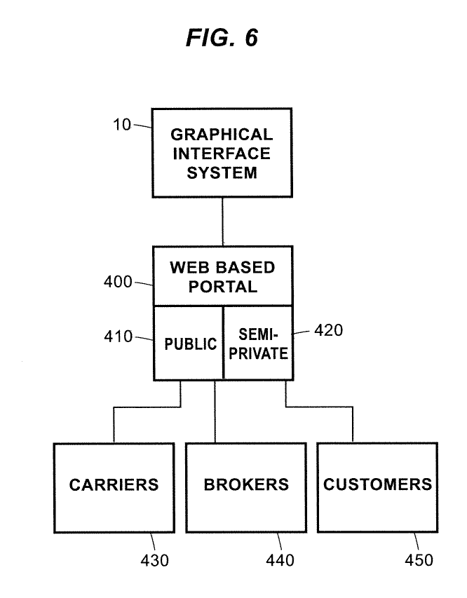

The graphical interface system 10 runs an active post query 80 and a historical post query 82 to match known available loads with known available transportation assets. The graphical interface system 10 then sends the matched loads and transportation assets back to the generic TMS module 62. The graphical interface system 10 may also receive data from a collaboration web based subscription 84. The collaboration web based subscription 84 includes, for example, shippers 86, warehouses 88, broker sales reps 90, broker carrier reps 92, and carriers 94. The collaboration web based subscription 84 sends data specific to an area of operation into a web based subscription, such as social network (See FIG. 6). The data is uploaded to a database 96, which is periodically accessed by the graphical interface system 10. The graphical interface system 10 analyzes the data from the database 96 and generates locations where a particular transportation company has no available assets 97, carrier preferred lanes 98, and carrier ratings 99. The carrier preferred lanes may be particular lanes that a certain carrier has expressed repeated interest in running. The carrier ratings may be reliability ratings that enhance cold calling opportunities. For example, a rep looking for an available transportation asset may have a choice between three different carriers. The rep will naturally call the carrier with the highest carrier rating first.

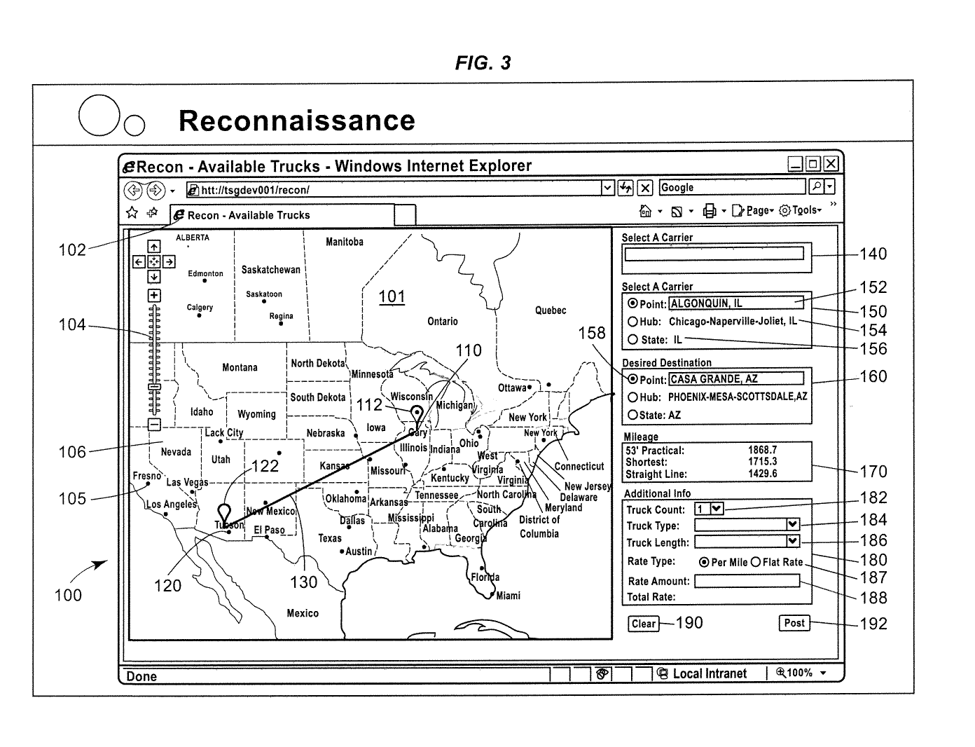

In FIG. 3, a display 100, such as a computer screen or other electronic display shows a map 101 of a desired region. For example, the map 101 shown in FIG. 3 depicts the lower forty eight states of the U.S. along with portions of Canada and Mexico. The region is selectable by the user and may be virtually any region of the globe for which map data can be obtained. A tab 102 on the display enables a user to select either transportation assets (shown in FIG. 3), or available loads (not shown in FIG. 3). The tab 102 tells the system what type of information is being entered and/or displayed. The map 101 may include a scale indicator 104 that allows a user to change the scale of the map 101. The map 101 may further include cities 105 and states 106. The map 101 may be customizable by the user to include virtually any geographical feature. For example, the map 101 may include highways, counties, terrain, etc.

Initially, the user graphically selects a first location 110 on the map 101 by placing a cursor over the first location 110 and activating the cursor with an activation device, for example, a computer mouse button. Once the first location 110 is selected, a flag 112 or other symbol is generated on the map 101 to identify the first location 110. A first location is changed by clicking and dragging the flag 112 to a new first selected location if desired. Generally, this first location 110 is an origin; however, the user may select a destination as the first location 110 if desired. A user then selects a second location 120 in the same manner and a flag 122 or other symbol is generated at the second location 120. The system then computes and displays a polyline 130 connecting the first and second locations 110, 120. This polyline 130 is generally known as a lane.

The user may select a carrier in a select carrier box 140 to tell the system which shipping company owns the particular asset being input. For example, the user may type in the name of the shipping company, or select a shipping company from a drop-down list. The system may automatically complete the entry once enough characters have been entered to determine the desired shipping company. This feature is generally known as an auto-complete feature and is available for any textual entry in the system. The system may also pre-populate known origins and destinations based on the selected carrier or customer.

Once a user selects the first location or origin 110, the system converts the first location to a latitude/longitude coordinate. The system then searches the map database for a nearest city, a nearest transportation hub and a nearest state. The system populates the fields in a truck available location box 150 with the searched information. The fields 152, 154, 156 reflect levels of granularity for the searched information. For example, the nearest city is displayed at 152, the nearest transportation hub is displayed at 154 and the nearest state is displayed at 156. These fields 152, 154, 156 are selectable by the user to set the desired first location or origin 110 to a specific location, such as a city, or more general location, such as a transportation hub or state.

The user then generally selects the second location or destination 120 in the same manner described above. The system converts the selected second or destination location to a latitude/longitude coordinate. The system then searches the map database for a nearest city, a nearest transportation hub and a nearest state. The user then has the option of selecting either the city, transportation hub or state in the selection points 158 in the detailed destination box 160, which were automatically populated by the system. In this manner, the system greatly improves the efficiency of data entry by allowing the user to click on a general location and the system then uses this information to refine and present choices to the user of nearby locations. Thus, the user need not click on the exact location desired and only needs to click in the general vicinity of the desired location.

Once first and second locations 110, 120 are selected, the system computes mileage between the first and second locations 110, 120. In the embodiment shown in FIG. 3, the system computes three different mileages, 53′ practical, shortest, and straight line, and displays the results in a mileage box 170. 53′ practical is the route a 53 foot long truck would generally take between the first and second locations 110, 120 based on various factors, such as overpass height, type of road (interstate, arterial, etc.), speed limit, etc. The shortest route is generally the shortest route over known roads regardless of other factors. Finally, the straight line route is a straight line between the first and second location.

An additional info box 180 allows a user to select additional information to add to the entry prior to saving the entry or posting the entry to a transportation management system. For example, if the user has entered an available transportation asset (e.g., an empty truck) and there is more than one transportation asset available, the user can select the appropriate number of assets in the drop-down box 182. Likewise, the user can select the type or length of truck at drop-down boxes 184 and 186. A basis for calculation of a rate to quote for transportation between the entered first and second locations 110, 120 is selected at box 187. The choices for calculating a rate are per mile and flat rate. The total rate is then displayed at box 188.

If the user does not want to save or post the information to a transportation management system, the clear button 190 clears the entry. Finally, once the user is satisfied with the data entered a post button 192 may be selected and the entered data is saved and/or uploaded to a transportation management system.

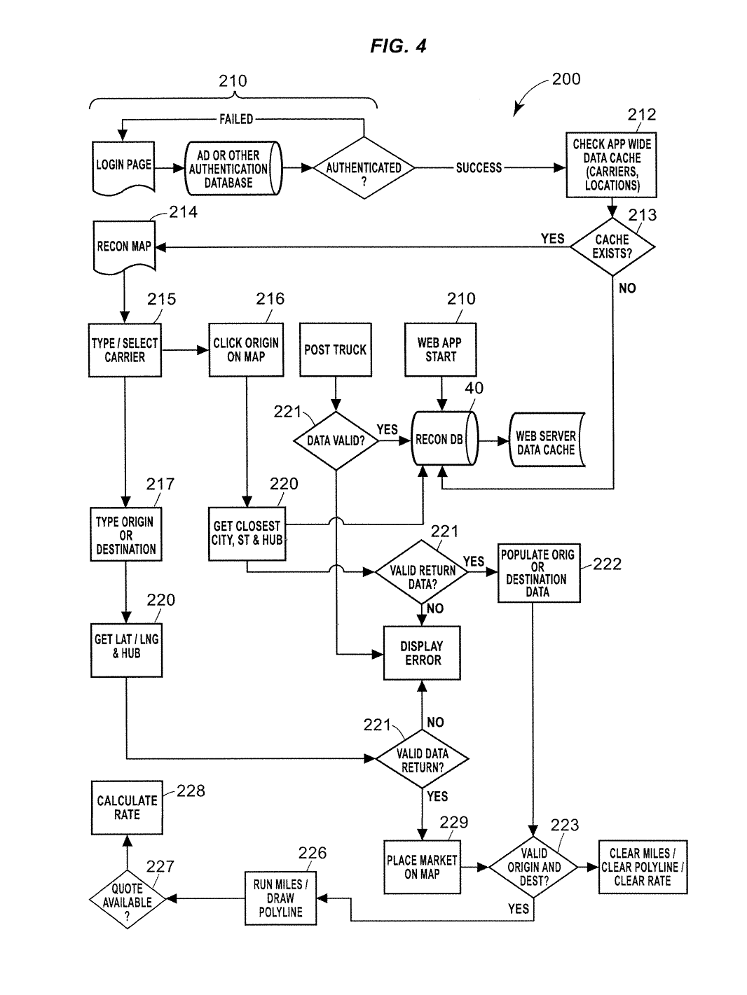

Turning now to FIG. 4, a logic diagram is depicted for the graphical entry system that generates the display of FIG. 3. The system 200 is initialized at boxes 210 and may be web based or stand alone. A password may be entered if desired to limit access to authorized parties. The login screen also allows the system 200 to track posts by individual users for historical and reliability analysis. The system 200 then checks cache data at box 212. The cache data is checked to ensure that the required data exists box 213 for both carrier and location functionality. If the cache data does not exist, it is retrieved from the database 40. A date/time is stored each time the cache data is refreshed and the system 200 can thus update the cache data at regular intervals to ensure current data.

After the system checks the cache data, a map is generated at box 214. The map may be generated by retrieving map data from a map database in a server, or from a local location. Regardless, the map may be customized by a user to a particular area of interest, for example, North America as shown in FIG. 3. Virtually any region of the globe may be shown on the map provided there is adequate access to map data from the region.

The map is an interactive map and a user may select a carrier/customer at box 215 and a location at boxes 216, 217 by either clicking a location on the map or textually entering the location into a text box on the display. The system 200 converts the selected location to a latitude/longitude point and searches for the nearest city, hub and state at box 220. The nearest city, hub, state data is sent to the database 40. Posted information may be checked for accuracy at box 221. After validating the data, a marker is placed on the map at box 229. In this manner, a user can rapidly ascertain available load and transportation assets and their relation to one another geographically. Further, if a particular location is not familiar to the user (e.g., Woodstock Ill.), the location is shown graphically and the user can readily identify known landmarks (e.g., Chicago Ill.) and immediately be familiar with the region by simply looking at the map. The origin and/or destination data is then populated on the display and the user may select between the populated data to determine the exact desired location.

Valid origin/destination data is checked at box 223, mileage between the first and second locations is calculated and a polyline is generated to connect the first and second locations at box 226. A quote is determined at box 227 and a rate is calculated at box 228 based on the mileage calculated and a rate/mile, or a flat rate. When posting load or transportation asset information the system generates a date/time stamp and attaches the date/time stamp to the information prior to saving or transmitting the data. In subsequent analysis, the system determines the age of any relevant information and assigns a level of confidence based in part on the age of the information. Additionally, multiple origins and destinations may be entered and posted together with one selection of the post button 192 (FIG. 3).

The system 200 also includes features that allow the user to selectively highlight particular carriers or particular customer loads. For example, the user may desire to only view available transportation assets from C.R. England company. The system then removes all non C.R. England company assets on the display. In this way, the user can efficiently search for a particular asset on a particular lane and thus match loads with assets quickly. Alternatively, the system may tag all C.R. England company assets on the display to highlight these assets to the user. Furthermore, the system may assign individual assets unique truck numbers. These unique truck numbers represent a real world individual driver and transportation vehicle. The system may perform historical analysis on individual drivers to determine, for example, where the individual driver is likely to travel on a particular day of the week, month, or year. Such an individual analysis greatly increases the efficiency of locating available transportation assets

The system may also display historical data for a particular lane or route, thus allowing the user to target solicitation efforts to the most likely candidates for availability when no transportation assets exist for a particular lane. For example, when the user gets new load information and needs to locate an available transportation asset, the system may generate a suggested list of carriers to contact based on the historical data. Likewise, the system can generate predicted transportation asset data, on which the user can base calls to calls to shipping customers to target these predicted transportation assets. Moreover, the system may calculate a probability of success for matching a load to a particular available transportation asset based on historical trends.

Reports of historical data may be generated to facilitate strategic decisions for the user, such as future growth opportunities and proper staffing of representatives. Additionally, checklists of preferred carriers may be generated when an available transportation asset is needed. The checklist may be based upon historical data of which transportation companies generally have available assets in a particular region. Thus, the user can target these carriers for phone calls or emails to determine if any available assets exist. Moreover, the system can prioritize load information when the user is communicating with a carrier and suggest alternate loads or routes. For example, if a carrier tells the user that he/she has an available asset from New York to Chicago and the user does not have a load going from New York to Chicago, the system may suggest an available load that needs to go from New York to St. Louis and the user can then query the carrier if an asset would be available to modify its route to the New York to St. Louis lane. In this manner, the system suggests combinations that are likely to succeed regardless of what the carrier tells the user is available. These features greatly decrease training costs for new users as the system automatically generates the correct questions to ask a carrier.

The system may also integrate real time weather and traffic data and show the data on the map. The system may gather real time weather and traffic information from a variety of sources including, but not limited to, commercial subscription services, the internet, the national weather service, etc. By visualizing real time weather and traffic data in the map, a rep can quickly suggest more efficient combinations of origins and destinations to a particular carrier. For example, if a carrier has an asset available from Nashville to Chicago and there is weather and traffic in Indianapolis, the rep may suggest a load from Memphis to Chicago, thus bypassing the weather and traffic problems in Indianapolis. The weather and traffic problems may be an incentive for the carrier to modify his/her plans and pick up the available load out in Memphis.

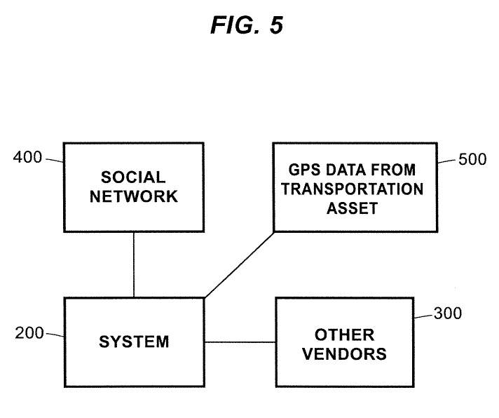

Other sources of data entry may be used. For example, as shown in FIG. 5, data may be entered directly from transportation management systems of other vendors 300, GPS or location data directly from the transportation asset 500 and/or web based communities such as a social network at 400. In each case, the outside data input supplies locations to the system 200 and the system then converts the location data to map data and displays the input data on the computer screen. The system 200 may also tag map data with a source of the data so that a user can determine where the information came from for transportation assets and loads. For example, a transportation asset may have a flag on the display to show that the particular asset information was generated by an outside vendor, such as DAT. Likewise, load data may be flagged showing that the data came directly from a customers' system. The flags may have different shapes, colors, etc. to identify a source of the displayed information. For example, user entered data may have a green colored flag (indicating a high level of reliability) while data from an external source may have a yellow colored flag.

Turning now to FIG. 6, the web based portal, or social network 400 is shown. The web based portal is a social network that users voluntarily join. Social networks generally serve as a virtual gathering place for people who share common interests. For example, myspace.com is an example of a social network. The web based portal 400 may have a publicly accessible portion 410 and a semi-private portion 420. Both the public portion 410 and the semi-private portion may have chat boards or instant message capability so that users such as carriers 430, brokers 440, and customers 450 may exchange information and socialize. The web based portal 400 may allow users to designate buddies or friends and allow access to the semi-private portion 420 for the buddies or friends. Furthermore, the web based portal 400 may have sites to gather information entered by the users. For example, the carriers may be interested in local food establishments and the web based portal 400 may have a catalog of such local food establishments. Additionally, the web based portal 400 may include blogs, stories from the road, user profiles, bulletin boards, music and video uploads, email, eCards, comments, favorites, calendar and reminders, events, announcements, etc. Moreover, the web based portal 400 may allow users to enter load and transportation asset data and share such data with their buddies or friends or the community at large. This load and transportation data may be periodically uploaded to the graphical interface system 10. In this manner, the web based portal 400 gathers critical load and transportation asset data that the users voluntarily enter. As a result, reps can use their time more efficiently.

While the detailed drawings, specific examples and particular formulations given describe exemplary embodiments, they serve the purpose of illustration only. The systems and methods shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A method for use in scheduling transfer of transportation assets from a first geographic location to a second geographic location, the method comprising:
providing a graphical representation of a map on an electronic display device;
enabling a user to graphically selecting a first geographical location on the map with a cursor and a cursor activation device to indicate a selected geographical location;
converting the selected geographical location into a geographic coordinate;
enabling a user to associate one of transportation asset data and load data to the selected geographical location; and
displaying the one of transportation asset data and load data associated with the selected geographical location on the electronic display device to facilitate scheduling of a transfer of a transportation asset or a load from the first geographic location to a second geographical location.

2. The method according to claim 1, further comprising sending the one of transportation asset data and load data to a transportation management system.

3. The method according to claim 1, further comprising searching for a transportation hub near the geographic coordinate before displaying the one of transportation asset data and load data on the electronic display device and displaying the transportation hub on the electronic display device.

4. The method according to claim 1, further comprising searching for a city near the geographic coordinate before displaying the one of transportation asset data and load data on the electronic display device and displaying the city on the electronic display device.

5. The method according to claim 1, further comprising generating a marker and displaying the marker on the map, the marker corresponding to the first geographical location on the map.

6. The method according to claim 1, further comprising associating date/time information with the one of transportation asset data and load data.

7. The method according to claim 5, further comprising assigning a level of confidence to the one of transportation asset data and load data based on the date/time information.

8. The method according to claim 1, further comprising assigning a unique truck number to the first geographical location.

9. The method according to claim 7, further comprising tracking historical data for the unique truck number.

10. The method according to claim 7, further comprising tracking reliability a driver associated with the unique truck number.

11. The method according to claim 1, further comprising generating a suggested list of carriers for contact based on historical data and available load data.

12. The method according to claim 10, further comprising generating and displaying a checklist for use in contacting the carriers in the suggested list.

13. The method according to claim 1, further comprising calculating a probability of success of finding an available transportation asset based on historical data and the first geographical location.

14. The method according to claim 1, further comprising suggesting an alternate load based on traffic and/or weather information along a lane of an available transportation asset.

15. The method according to claim 1, further comprising displaying real time traffic and/or weather data on the electronic display device.

16. The method according to claim 1, further comprising gathering transportation asset data from one of a GPS, a transportation asset, a web based community and a social network.

17. A system for graphical entry of transportation asset data into a transportation management system, comprising:
a processor connected to a memory and a map database;
a first routine stored in the memory and executable on the processor to create a graphical representation of a map on an electronic display device;
a second routine stored in the memory and executable on the processor to enable a user to graphically select a first geographical location on the map;
a third routine stored in the memory and executable on the processor to enable the user to associate one of transportation asset data and load data with the first geographical location; and
a fourth routine stored in the memory and executable on the processor to send transportation asset data or load data associated with the first geographical location to the electronic display.

18. The system of claim 17 further comprising a fifth routine stored in the memory and executable on the processor to generate one of a select carrier area and an available transportation vehicle area on the map and associate data from one of the select carrier area and the available transportation vehicle area with the first geographical location.

19. The system of claim 17 further comprising a social network connected to the processor, the processor obtaining one of transportation asset data and load data from the social network and displaying the one of transportation asset data and load data on the electronic display.
